(19) United States
(12) Patent Application Publication
(10) Pub. No.: US 2026/0348319 A1
(43) Pub. Date: Nov. 5, 2026

(54) COMBINED CYCLE POWER PRODUCTION

(71) Applicant: NET Power LLC, Durham, NC (US)

(72) Inventors: Xijia Lu, Salt Lake City, UT (US); Scott Thomas Martin, Salt Lake City, UT (US); Nathan Davis, Kaysville, UT (US)

(73) Assignee: NET Power LLC, Durham, NC (US)

(21) Appl. No.: 19/645,630

(22) Filed: Apr. 13, 2026

Related U.S. Application Data
(60) Provisional application No. 63/788,595, filed on Apr. 14, 2025.

(51) Int. Cl. F02C 3/34; F02C 3/30

(52) U.S. Cl. CPC F02C 3/34; F02C 3/30; F05D 2260/213; F05D 2260/606; F05D 2260/609

(57) ABSTRACT

Methods and systems for generating power are disclosed. A combustor combusts a carbonaceous fuel stream with an oxidant in the presence of a recycle CO₂ stream. The resultant working fluid drives a combustion turbine and then is cooled in a recuperative heat exchanger. A second working fluid is heated by the recuperative heat exchanger, drives a cycle turbine, and is reconstituted.

### CROSS-REFERENCE TO RELATED APPLICATIONS

This application claims the benefit of U.S. Provisional Patent Application No. 63/788,595, filed Apr. 14, 2025 and entitled “Combined Cycle Power Production,” the entire contents of which are incorporated by reference herein.

### TECHNICAL FIELD

The present disclosure relates to combined cycle power production, for example for use with oxy-fuel combustion systems.

### BACKGROUND

Combustion systems, including the Allam Cycle, may utilize a carbonaceous fuel, an oxidant stream, and a recycled carbon dioxide stream to produce energy. The oxidant and recycle streams require energy inputs to produce. For certain details of the Allam Cycle, see U.S. Pat. No. 8,596,075, the entire contents of which are incorporated by reference herein.

### SUMMARY

In some examples, the present disclosure provides a system for generating power. The system includes a combustor to combust a carbonaceous fuel stream with an oxidant stream in the presence of a recycle CO₂ stream, and to produce a first working fluid stream primarily consisting of subcritical CO₂. The system includes a combustion turbine to receive the first working fluid stream to drive a first generator to generate first power. The system includes a recuperative heat exchange system to cool the first working fluid stream. The system includes a primary multistage compression system comprising one or more compressors and interstage coolers to compress and dry the first working fluid stream to produce a dry CO₂ fluid stream.

The system includes the recuperative heat exchange system to heat a first portion of the dry CO₂ fluid stream to produce the recycle CO₂ stream; heat a mix of an oxygen stream and a second portion of the dry CO₂ fluid stream to produce the oxidant stream; heat the carbonaceous fuel stream before the combustor; and heat a cold second working fluid stream to produce a second working fluid stream. The system includes an air-separation unit (ASU) to produce the oxygen stream, the ASU containing an ASU dehydration unit to dehydrate the oxygen stream. The system includes a carbon dioxide-purification unit (CPU) to process a third portion of the dry CO₂ fluid stream to produce an export CO₂ stream, the CPU containing a CPU dehydration unit to dehydrate the export CO₂ stream. The ASU dehydration unit receives a first portion of the second working fluid stream to regenerate the ASU dehydration unit. The CPU dehydration unit receives a second portion of the second working fluid stream to regenerate the CPU dehydration unit. The system includes a cycle turbine to receive a third portion of the second working fluid stream to drive a second generator to generate second power. The system includes a compression system, a condensing system, or both a compression system and a condensing system to compress, condense, or compress and condense the third portion of the second working fluid stream to produce a portion of the cold second working fluid stream.

In some examples, the carbonaceous fuel stream includes, or consists essentially of, natural gas.

In some examples, the carbonaceous fuel stream includes, or consists essentially of, a solid fuel.

In some examples, the CPU includes an export compressor to compress the third portion of the dry CO₂ fluid stream to pipeline pressure.

In some examples, the CPU is configured to remove contaminants from the third portion of the dry CO₂ fluid stream, the contaminants selected from the group consisting of NOx, SOx, CO, and water.

In some examples, the second working fluid stream includes, or consists essentially of, steam and the water from the purification system is used as makeup water for the cold second working fluid stream.

In some examples, the system includes a bleed valve to bleed the second working fluid stream to atmosphere during an upset condition.

In some examples, the second working fluid stream includes, or consists essentially of, steam.

In some examples, water from the primary multistage compression system is used as makeup water for the cold second working fluid stream.

In some examples, the second working fluid stream includes, or consists essentially of, carbon dioxide.

In some examples, the second working fluid stream includes, or consists essentially of, nitrogen.

In some examples, the system includes an external process producing heat, the external process to pass the heat through the recuperative heat exchange system to provide heat to any process streams passing through the recuperative heat exchange system. In some examples, the external process includes, or consists essentially of, a gas turbine.

In some examples, the system includes one or more additional combustors and one or more additional combustion turbines in series with the combustor and the combustion turbine, the one or more additional combustors to combust additional carbonaceous fuel streams with additional oxidant streams in the presence of additional recycle CO₂ streams, the combustion turbine and the one or more additional combustion turbines to receive the first working fluid stream and additional first working fluid streams from the combustor and the one or more additional combustors, respectively, the combustion turbine and the one or more additional combustion turbines to pass the first working fluid stream and the additional first working fluid streams to a next of the one or more additional combustors, and the last of the one or more additional combustors to pass a last of the additional first working fluid streams to the recuperative heat exchange system.

In some examples, each of the one or more additional combustors comprise a pressure of a previous combustion turbine discharge or a previous of the one or more additional combustion turbines discharge.

In some examples, the combustion turbine and the one or more additional combustion turbines are configured to drive the first shaft.

In some examples, each of the one or more additional combustion turbines are configured to drive one or more additional shafts and one or more additional generators.

In some examples, the recuperative heat exchange system includes, or consists essentially of, a plurality of recuperative heat exchangers in series, parallel, or series and parallel.

In some examples, the cycle turbine includes, or consists essentially of, a plurality of sub-turbines on the second shaft, the plurality of sub-turbines to pass the second working fluid stream through the recuperative heat exchange system before a next of the plurality of cycle turbines to reheat the second working fluid stream.

In some examples, the first working fluid stream enters the combustion turbine at a pressure ranging from 20 bar to 120 bar and a temperature ranging from 800 °C to 2000 °C

In some examples, the first working fluid stream enters the combustion turbine at a pressure ranging from 25 bar to 65 bar and a temperature ranging from 1100 °C to 1700 °C

In some examples, the first working fluid stream exits the combustion turbine at a pressure ranging from atmospheric pressure to below the pressure of an inlet of the combustion turbine and a temperature ranging from 600 °C to 900 °C

In some examples, the first working fluid stream exits the combustion turbine at a pressure below 5 bar and a temperature ranging from 700 °C to 800 °C

In some examples, the present disclosure provides a system for generating power. The system includes a combustor to combust a carbonaceous fuel stream with an oxidant stream in the presence of a recycle CO₂ stream, and to produce a first working fluid stream primarily consisting of subcritical CO₂. The system includes a combustion turbine to receive the first working fluid stream to drive a first generator to generate first power. The system includes a recuperative heat exchange system to cool the first working fluid stream. The system includes a primary multistage compression system comprising one or more compressors and interstage coolers to compress and dry the first working fluid stream to produce a dry CO₂ fluid stream, wherein a first portion of the dry CO₂ fluid stream comprises the recycle CO₂ stream. The recuperative heat exchange system heats a cold second working fluid stream to produce a second working fluid stream. The system includes an air-separation unit (ASU) to produce an oxygen stream, the ASU containing an ASU dehydration unit to dehydrate the oxygen stream, wherein the oxidant stream includes a second portion of the dry CO₂ fluid stream and the oxygen stream. The system includes a carbon dioxide-purification unit (CPU) to process a third portion of the dry CO₂ fluid stream to produce an export CO₂ stream, the CPU including a CPU dehydration unit to dehydrate the export CO₂ stream. The ASU dehydration unit receives a first portion of the second working fluid stream to regenerate the ASU dehydration unit. The CPU dehydration unit receives a second portion of the second working fluid stream to regenerate the CPU dehydration unit. The system includes a cycle turbine to receive a third portion of the second working fluid stream to drive a second generator to generate second power. The system includes a compression system, a condensing system, or both a compression system and a condensing system to compress, condense, or compress and condense the third portion of the second working fluid stream to produce a portion of the cold second working fluid stream.

In some examples, the present disclosure provides a system for generating power. The system includes a plurality of power generating units. The power generating units include a combustor to combust a carbonaceous fuel stream with an oxidant stream in the presence of a recycle CO₂ fluid stream, and to produce a first working fluid stream primarily consisting of subcritical CO₂. The power generating units include a combustion turbine to receive the first working fluid stream to drive a first generator to generate first power. The power generating units include a recuperative heat exchange system to cool the first working fluid stream. the recuperative heat exchange system heats a cold second working fluid stream to produce a second working fluid stream. The power generating units include a cycle turbine to receive the second working fluid stream to drive a second generator to generate second power. The power generating units include a compression system, a condensing system, or both a compression system and a condensing system to compress, condense, or compress and condense the second working fluid stream to produce the cold second working fluid stream. A previous of the plurality of power generating units passes a previous of the first working fluid streams to the combustor of a next of the plurality of power generating units. A last of the plurality of power generating units passes a last of the first working fluid streams to a primary multistage compression system. The primary multistage compression system includes one or more compressors and interstage coolers to compress and dry the last of the first working fluid streams to produce a dry CO₂ fluid stream. A first portion of the dry CO₂ fluid stream includes, or consists essentially of, the recycle CO₂ fluid stream.

In some examples, the system includes an air-separation unit (ASU) to produce an oxygen stream, the ASU including an ASU dehydration unit to dehydrate the oxygen stream, wherein the oxidant stream includes, or consists essentially of, a second portion of the dry CO₂ fluid stream and the oxygen stream. In some examples, the ASU dehydration unit receives a portion of one of the second working fluid streams to regenerate the ASU dehydration unit.

In some examples, the system includes a carbon dioxide-purification unit (CPU) to process a third portion of the dry CO₂ fluid stream to produce an export CO₂ stream, the CPU comprising a CPU dehydration unit to dehydrate the export CO₂ stream. In some examples, the CPU dehydration unit receives a second portion of one of the second working fluid streams to regenerate the CPU dehydration unit.

In some examples, the recuperative heat exchange system heats the recycle CO₂ stream. In some examples, the recuperative heat exchange system heats the oxidant stream.

In some examples, the present disclosure provides a system for generating power. The system includes a combustor to combust a carbonaceous fuel stream with an oxidant stream in the presence of a first recycle CO₂ stream, and to produce a first working fluid stream. The system includes a combustion turbine to receive the first working fluid stream and a second recycle CO₂ stream to drive a first generator to generate first power. The system includes a recuperative heat exchange system to cool the first working fluid stream and the first recycle CO₂ stream. The system includes a primary compression system comprising one or more compressors to compress the first working fluid stream to produce the first recycle CO₂ stream, the second recycle CO₂ stream, an oxidant CO₂ stream, and a product CO₂ stream. The recuperative heat exchange system further heats a mix of an oxygen stream and the oxidant CO₂ stream to produce the oxidant stream and heats a cold second working fluid stream to produce a second working fluid stream. The system includes an air-separation unit (ASU) to produce the oxygen stream, the ASU comprising an ASU dehydration unit to dehydrate the oxygen stream.

The system includes a carbon dioxide-purification unit (CPU) to process product CO₂ stream to produce an export CO₂ stream, the CPU comprising a CPU dehydration unit to dehydrate the export CO₂ stream. The system includes the ASU dehydration unit to receive a first portion of the second working fluid stream to regenerate the ASU dehydration unit. The system includes the CPU dehydration unit to receive a second portion of the second working fluid stream to regenerate the CPU dehydration unit. The system includes a cycle turbine to receive a third portion of the second working fluid stream to drive a second generator to generate second power. The system includes a compression system, a condensing system, or both a compression system and a condensing system to compress, condense, or compress and condense the third portion of the second working fluid stream to produce a portion of the cold second working fluid stream.

In some examples, the recuperative heat exchange system heats the carbonaceous fuel stream before the combustor.

In some examples, the present disclosure provides a method for generating power. The method includes combusting a carbonaceous fuel stream and an oxidant stream in the presence of a recycle CO₂ fluid stream in a combustor, generating a working fluid stream primarily consisting of subcritical CO₂. The method includes passing the working fluid stream through a combustion turbine, driving a first generator, generating first power. The method includes cooling the working fluid stream by indirect-contact heat exchange through a recuperative heat exchange system. The method includes dehydrating and compressing the working fluid stream to produce a dry CO₂ fluid stream. The method includes heating a first portion of the dry CO₂ fluid stream by indirect-contact heat exchange through the recuperative heat exchange system to produce the recycle CO₂ fluid stream. The method includes producing an oxygen stream in an air-separation unit (ASU). The method includes dehydrating the oxygen stream in an ASU dehydration unit. The method includes combining the oxygen stream with a second portion of the dry CO₂ fluid stream to produce the oxidant stream. The method includes heating the oxidant stream by indirect-contact heat exchange through the recuperative heat exchange system. The method includes heating the carbonaceous fuel stream by indirect-contact heat exchange through the recuperative heat exchange system. The method includes processing a third portion of the dry CO₂ fluid stream through a carbon dioxide purification unit to produce an export CO₂ stream. The method includes dehydrating the export CO₂ stream in a CPU dehydration unit. The method includes heating a second cold working fluid stream by indirect-contact heat exchange through the recuperative heat exchange system to produce a second working fluid stream. The method includes passing a first portion of the second working fluid stream through the ASU dehydration unit to regenerate the ASU dehydration unit. The method includes passing a second portion of the second working fluid stream through the CPU dehydration unit to regenerate the CPU dehydration unit. The method includes passing a third portion of the second working fluid stream through a cycle turbine, driving a second generator, generating second power. The method includes compressing, condensing, or compressing and condensing the third portion of the second working fluid stream to produce a portion of the cold second working fluid stream.

In some examples, the carbonaceous fuel stream includes, or consists essentially of, natural gas. In some examples, the carbonaceous fuel stream includes, or consists essentially of, a solid fuel.

In some examples, the processing step includes compressing a third portion of the dry CO₂ fluid stream to pipeline pressure.

In some examples, the processing step includes removing contaminants from the third portion of the dry CO₂ fluid stream, the contaminants selected from the group consisting of NOx, SOx, CO, and water.

In some examples, the method includes transferring heat from the CPU to the recuperative heat exchange system.

In some examples, the second working fluid stream includes, or consists essentially of, steam and the method further includes passing water from the CPU to act as makeup water for the cold second working fluid stream.

In some examples, the method includes bleeding the second working fluid stream to atmosphere during an upset condition.

In some examples, the second working fluid stream includes, or consists essentially of, steam.

In some examples, the method includes using water from the dehydrating and compressing step as makeup water for the cold second working fluid stream.

In some examples, the second working fluid stream includes, or consists essentially of, carbon dioxide.

In some examples, the second working fluid stream includes, or consists essentially of, nitrogen.

In some examples, the method includes producing heat in an external process and passing the heat through the recuperative heat exchange system, providing heat to any process streams passing through the recuperative heat exchange system.

In some examples, the external process is a gas turbine.

In some examples, the method includes having one or more additional combustors and one or more additional combustion turbines in series with the combustor and the combustion turbine and combusting additional carbonaceous fuel streams with additional oxidant streams in the presence of additional recycle CO₂ streams in the one or more additional combustors, receiving the first working fluid stream and additional first working fluid streams from the combustor and the one or more additional combustors in the combustion turbine and the one or more additional combustion turbines, respectively, passing the first working fluid stream and the additional first working fluid streams from the combustion turbine and the one or more additional combustion turbines to a next of the one or more additional combustors, and passing a last of the additional first working fluid streams from the last of the one or more additional combustors to the recuperative heat exchange system.

In some examples, each of the one or more additional combustors has a pressure of a previous combustion turbine discharge or a previous of the one or more additional combustion turbines discharge.

In some examples, the method includes driving the first shaft by the one or more additional combustion turbines.

In some examples, the method includes driving one or more additional shafts and one or more additional generators by the one or more additional combustion turbines.

In some examples, the recuperative heat exchange system includes, or consists essentially of, a plurality of recuperative heat exchangers in series, parallel, or series and parallel.

In some examples, the cycle turbine includes, or consists essentially of, a plurality of sub-turbines on the second shaft. The method further may include passing the second working fluid stream from the plurality of sub-turbines through the recuperative heat exchange system before a next of the plurality of cycle turbines, reheating the second working fluid stream.

In some examples, the first working fluid stream enters the combustion turbine at a pressure ranging from 20 bar to 120 bar and a temperature ranging from 800 °C to 2000 °C. In other examples, the first working fluid stream enters the combustion turbine at a pressure ranging from 25 bar to 65 bar and a temperature ranging from 1100 °C to 1700 °C

In some examples, the first working fluid stream exits the combustion turbine at a pressure ranging from atmospheric pressure to below the pressure of an inlet of the combustion turbine and a temperature ranging from 600 °C to 900 °C. In other examples, the first working fluid stream exits the combustion turbine at a pressure below 5 bar and a temperature ranging from 700 °C to 800 °C

In some examples, the present disclosure provides a method for generating power. The method includes combusting a carbonaceous fuel stream and an oxidant stream in the presence of a recycle CO₂ fluid stream in a combustor, generating a working fluid stream primarily comprising subcritical CO₂. The method includes passing the working fluid stream through a combustion turbine, driving a first generator, generating first power. The method includes cooling the working fluid stream by indirect-contact heat exchange through a recuperative heat exchange system. The method includes dehydrating and compressing the working fluid stream to produce a dry CO₂ fluid stream, wherein a first portion of the dry CO₂ fluid stream is the recycle CO₂ fluid stream. The method includes producing an oxygen stream in an air-separation unit (ASU). The method includes dehydrating the oxygen stream in an ASU dehydration unit, wherein the oxygen stream and a second portion of the dry CO₂ fluid stream comprises the oxidant stream. The method includes processing a third portion of the dry CO₂ fluid stream through a carbon dioxide purification unit to produce an export CO₂ stream. The method includes dehydrating the export CO₂ stream in a CPU dehydration unit. The method includes heating a second cold working fluid stream by indirect-contact heat exchange through the recuperative heat exchange system to produce a second working fluid stream. The method includes regenerating a first portion of the second working fluid stream to regenerate the ASU dehydration unit. The method includes regenerating a second portion of the second working fluid stream to regenerate the CPU dehydration unit. The method includes passing a third portion of the second working fluid stream through a cycle turbine, driving a second generator, generating second power. The method includes compressing, condensing, or compressing and condensing the third portion of the second working fluid stream to produce a portion of the cold second working fluid stream.

In some examples, the present disclosure provides a method for generating power. The method includes generating power in a plurality of staged processes. The staged processes include combusting a carbonaceous fuel stream and an oxidant stream in the presence of a recycle CO₂ fluid stream in a combustor, generating a working fluid stream primarily comprising subcritical CO₂. The staged processes include passing the working fluid stream through a combustion turbine, driving a first generator, generating first power. The staged processes include cooling the working fluid stream by indirect-contact heat exchange through a recuperative heat exchange system. The staged processes include heating a second cold working fluid stream by indirect-contact heat exchange through the recuperative heat exchange system to produce a second working fluid stream. The staged processes include passing the second working fluid stream through a cycle turbine, driving a second generator, generating second power. The staged processes include compressing, condensing, or compressing and condensing the second working fluid stream to produce the cold second working fluid stream. The method includes a previous of the plurality of staged processes passing a previous of the first working fluid streams to the combustor of a next of the plurality of staged processes. The method includes a last of the plurality of staged processes dehydrating and compressing a last of the first working fluid streams to produce a dry CO₂ fluid stream, wherein a first portion of the dry CO₂ fluid stream is the recycle CO₂ fluid stream.

In some examples, the method includes producing an oxygen stream in an air-separation unit (ASU) and dehydrating the oxygen stream in an ASU dehydration unit, wherein the oxidant stream includes, or consists essentially of, a second portion of the dry CO₂ fluid stream and the oxygen stream. In some examples, the method includes passing a second portion of the second working fluid stream through the ASU dehydration unit to regenerate the ASU dehydration unit.

In some examples, the method includes processing a third portion of the dry CO₂ fluid stream through a carbon dioxide purification unit to produce an export CO₂ stream and dehydrating the export CO₂ stream in a CPU dehydration unit.

In some examples, the method includes heating the recycle CO₂ stream through the recuperative heat exchange system.

In some examples, the method includes heating the oxidant stream through the recuperative heat exchange system.

In some examples, the present disclosure provides a method for generating power. The method includes combusting a carbonaceous fuel stream and an oxidant stream in the presence of a first recycle CO₂ fluid stream in a combustor, generating a working fluid stream. The method includes passing the working fluid stream and a second recycle CO₂ fluid stream through a combustion turbine, driving a first generator, generating first power. The method includes cooling the working fluid stream and the first recycle CO₂ fluid stream by indirect-contact heat exchange through a recuperative heat exchange system. The method includes compressing the working fluid stream to produce the first recycle CO₂ fluid stream, the second recycle CO₂ fluid stream, an oxidant CO₂ stream, and a product CO₂ stream. The method includes producing an oxygen stream in an air-separation unit (ASU). The method includes dehydrating the oxygen stream in an ASU dehydration unit. The method includes combining the oxygen stream with the oxidant CO₂ stream to produce the oxidant stream. The method includes heating the oxidant stream by indirect-contact heat exchange through the recuperative heat exchange system. The method includes processing the product CO₂ stream through a carbon dioxide purification unit (CPU) to produce an export CO₂ stream. The method includes dehydrating the export CO₂ stream in a CPU dehydration unit. The method includes heating a second cold working fluid stream by indirect-contact heat exchange through the recuperative heat exchange system to produce a second working fluid stream. The method includes passing a first portion of the second working fluid stream through the ASU dehydration unit to regenerate the ASU dehydration unit. The method includes passing a second portion of the second working fluid stream through the CPU dehydration unit to regenerate the CPU dehydration unit. The method includes passing a third portion of the second working fluid stream through a cycle turbine, driving a second generator, generating second power. The method includes compressing, condensing, or compressing and condensing the third portion of the second working fluid stream to produce a portion of the cold second working fluid stream.

In some examples, the method includes heating the carbonaceous fuel stream by indirect-contact heat exchange through the recuperative heat exchange system before the combustor.

Further examples are provided in the drawings, detailed description, and claims.

### BRIEF DESCRIPTION OF DRAWINGS

The following drawings are provided to illustrate certain embodiments described herein. The drawings are merely illustrative and are not intended to limit the scope of the claims and are not intended to show every potential feature or embodiment that is claimed. The drawings are not necessarily drawn to scale; in some instances, certain elements of the drawing may be enlarged with respect to other elements of the drawing for purposes of illustration.

FIG. 1 is a process diagram showing an example system for generating power.

FIG. 2 is a process diagram showing an example system for generating power.

FIG. 3 is a process diagram showing an example system for generating power.

FIG. 4 is a process diagram showing an example of the details of the cycle turbine from FIG. 1 or FIG. 5.

FIG. 5 is a process diagram showing an example system for generating power.

### DETAILED DESCRIPTION

The following description recites various aspects and embodiments of the subject matter disclosed herein. No particular embodiment is intended to define the scope of the present subject matter. Rather, the embodiments provide non-limiting examples of various compositions, and methods that are included within the scope of the claimed subject matter. The description is to be read from the perspective of one of ordinary skill in the art. Therefore, information that is well known to the ordinarily skilled artisan is not necessarily included.

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, “about” means within ±10% of the stated value, e.g., within ±5% of the stated value, or within ±2% of the stated value.

The present disclosure discusses development of facilities that produce power while capturing emissions at low costs. Systems that operate at lower pressures compared to current state of the art combustion facilities further reduce cost and avoid known challenges. Further, the present disclosure enhances the ability to use of off the shelf components. The systems and methods may utilize waste energy and waste heat, while taking into consideration techno-economic optimization. The need for high temperature, high pressure, compact, high-cost heat exchangers can be eliminated, whereas a previously known Allam Cycle would require all of these. A low pressure cycle can produce more heat than what the recycled CO₂ and input O₂ can absorb, which is why the present disclosure provides methods and systems for driving a bottoming cycle, such as steam or compressed gases. Further, steam can be integrated into regeneration of air-separation unit and carbon dioxide purification unit dehydration systems.

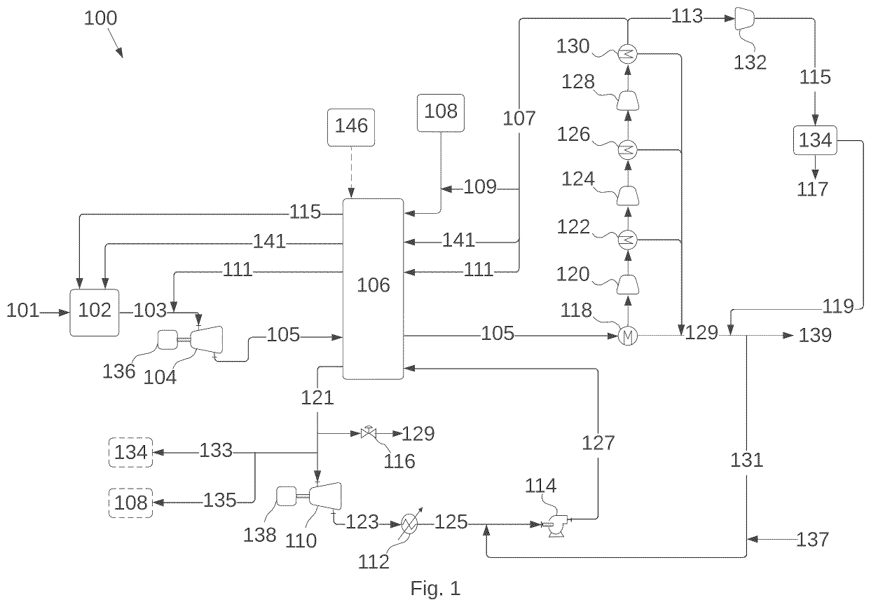

Now referring to FIG. 1, FIG. 1 is a process diagram showing an example system 100 for generating power. This example is purely illustrative, and multiple other examples are envisioned or may be readily envisioned without undue experimentation.

In some examples, system 100 is a combined cycle for generating power from two generators. In the nonlimiting configuration illustrated in FIG. 1, system 100 includes a combustor 102; a combustion turbine 104; a first generator 136; a recuperative heat exchange system 106; a multi-stage compressor with first condenser 118, first compressor 120, second condenser 122, second compressor 124, third condenser 126, third compressor 128, and fourth condenser 130; an air-separation unit 108; an export gas compressor 132; a cycle turbine 110; a second generator 138; a cycle condenser 112; a cycle pump 114; a carbon-purification unit 134; and a bleed valve 116.

A carbonaceous fuel stream 101, illustratively natural gas, is combusted in combustor 102 in the presence of an oxidant stream 115 and a recycle CO₂ stream 141. In one nonlimiting example, these streams enter the combustor 102 at about 30 bar, with oxidant stream 115 at 610 °C and 30 bar, fuel stream 101 at 30 °C and 30 bar, and recycle CO₂ stream 141 at 610 °C and 30 bar. The combustor 102 produces first working fluid stream 103 at 1180 °C and 30 bar, passing it to combustion turbine 104. Stream 103 drives the turbine 104, driving the turbine's shaft, which drives a first generator 136, generating power.

In some examples, the first working fluid stream enters the combustion turbine at a pressure ranging from 20 bar to 120 bar and a temperature ranging from 800 °C to 2000 °C. In other examples, the first working fluid stream enters the combustion turbine at a pressure ranging from 25 bar to 65 bar and a temperature ranging from 1100 °C to 1700 °C

In some examples, the first working fluid stream exits the combustion turbine at a pressure ranging from atmospheric pressure to below the pressure of an inlet of the combustion turbine and a temperature ranging from 600 °C to 900 °C. In other examples, the first working fluid stream exits the combustion turbine at a pressure below 5 bar and a temperature ranging from 700 °C to 800 °C.

The first working fluid stream 103 leaves the combustion turbine 104 as stream 105 and is cooled through the recuperative heat exchange system 106. The recuperative heat exchange system 106 may be a single heat exchanger, multiple heat exchangers in series, multiple heat exchangers in parallel, or a combination of heat exchangers in series and in parallel. Stream 105 is further cooled in condenser 118, compressed in compressor 120, and then cooled and compressed further in condenser 122, compressor 124, condenser 126, compressor 128, and condenser 130. Each of the condensers act as interstage coolers and produce water, which may be combined together as water stream 129. The first working fluid stream 105 then splits to become a dry CO₂ fluid stream 107 and an export stream 113. Export fluid stream 113 is compressed in compressor 132 and passed as stream 115 to carbon-purification unit 134 where water is condensed as stream 119, contaminants such as NOx, SOx, and CO are removed, and pipeline grade CO₂ gas 117 is exported to a pipeline.

In the nonlimiting example illustrated in FIG. 1, the dry CO₂ fluid stream 107 is split three ways. A first portion becomes the recycle CO₂ stream 141. A second portion combines with oxygen from air-separation unit 108 to form oxidant stream 115. A third portion is used as coolant 111.

In this example, a second cycle is combined with the above cycle. Illustratively, the second cycle may include a steam cycle. While deaeration, water treatment, and similar are not shown explicitly in the figures, these standard systems for producing steam are understood as standard and implied. A second working fluid stream 127 (boiler feed water) is heated across the recuperative heat exchange system 106, producing steam stream 121. A portion of the steam 133 is sent to regenerate the dehydration system of carbon-purification unit 134. A portion of the steam 135 is sent to regenerate the dehydration system of the air-separation unit 108. The remainder of steam stream 121 drives cycle turbine 110, driving a second shaft, driving a second generator 138, and producing further power. The discharge stream 123 is condensed in condenser 112 to produce a condensate 125. Makeup water 131 is added and the combination pumped by pump 114 as second working fluid stream 127. If insufficient makeup water 131 is present from produced water, additional makeup water 137 is provided.

Produced water is any water condensed from the CO₂ condensation or purification steps. Any produced water not used as makeup water 131 is discharged as water discharge 139.

During shutdown or upset conditions, bleed valve 116 opens and bleeds steam to atmosphere as discharge steam stream 129.

In some examples, an outside process 146, such as a gas turbine, produces heat that is used to further heat the recuperative heat exchanger 106.

In some examples, all of the process streams are subcritical. In some examples, some of the second cycle process streams are supercritical but the rest of the process streams are subcritical.

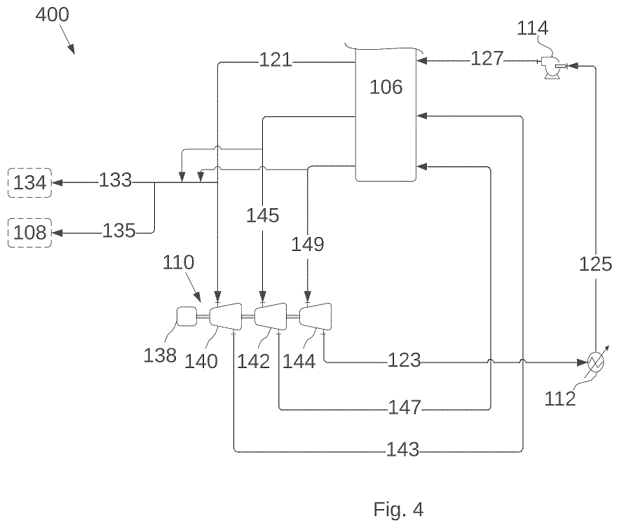

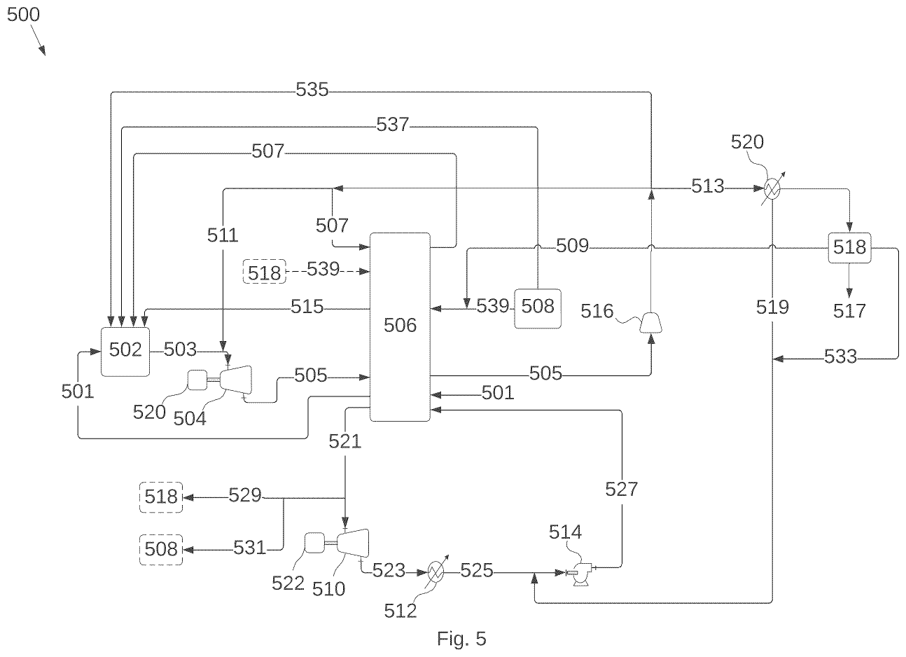

FIG. 4 is a process diagram showing an example 400 of cycle turbine 110 from FIG. 1 or cycle turbine 510 from FIG. 5. This example is purely illustrative, and multiple other examples are envisioned or may be readily envisioned without undue experimentation.

In the nonlimiting configuration illustrated in FIG. 4, turbine 110 includes high-pressure stage (HP stage) 140, intermediate-pressure stage (IP stage) 142, and low-pressure stage (LP stage) 144. Feed water 127 is heated across recuperative heat exchange system 106 to produce high-pressure steam 121 which is passed through the HP stage 140 to drive generator 138, generating stream 143. Stream 143 is heated through recuperative heat exchange system 106, producing intermediate-pressure steam 145. Stream 145 is passed through the IP stage 142 to drive generator 138, generating stream 147. Stream 147 is heated through recuperative heat exchange system 106, producing low-pressure steam 149. Stream 149 is passed through the LP stage 144 to drive generator 138, generating stream 123. Stream 123 is condensed in condenser 112, generating stream 125, which is pumped by pump 114, generating feed water 127.

Steam for streams 133 and 135 may be sourced from high, intermediate, or low-pressure steam streams 121, 145, or 149, respectively, as appropriate for the regenerative processes.

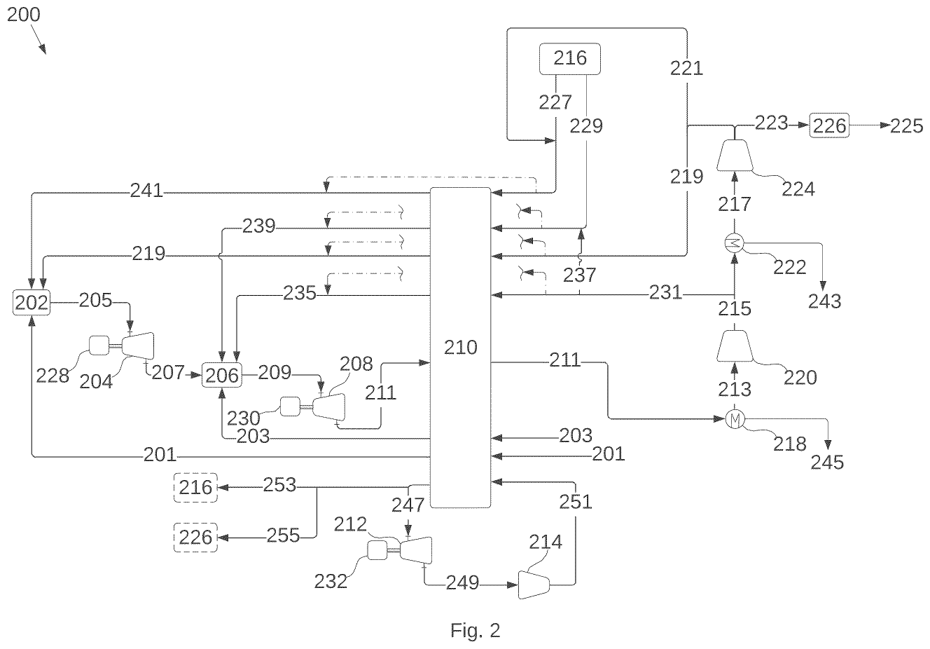

FIG. 2 is a process diagram showing an example system 200 for generating power. This example is purely illustrative, and multiple other examples are envisioned or may be readily envisioned without undue experimentation.

In some examples, system 200 is a combined cycle for generating power from two generators. In the nonlimiting configuration illustrated in FIG. 2, system 200 includes a first combustor 202, a first combustion turbine 204, a first combustion generator 228, a second combustor 206, a second combustion turbine 208, a second combustion generator 230, a recuperative heat exchange system 210, a cycle turbine 212, a cycle generator 232, a cycle compressor 214, an air-separation unit 216, a first condenser 218, a first compressor 220, a second condenser 222, a second compressor 224, and a carbon dioxide purification unit 226.

In this example, a first carbonaceous fuel stream 201 is heated across recuperative heat exchange system 210 and combusted with first oxidant stream 241 in the presence of a first recycle CO₂ stream 219 to produce first primary working fluid stream 205. Stream 205 drives first combustion turbine 204 and leaves as stream 207. Second carbonaceous fuel stream 203 is heated across recuperative heat exchange system 210 and combusted with second oxidant stream 239 in the presence of stream 207 and second recycle CO₂ stream 235 to produce second primary working fluid stream 209. Stream 209 drives second combustion turbine 208 and leaves as stream 211. First combustor 202 is at a higher pressure than second combustor 206. Second combustor 206 is at the discharge pressure of first combustion turbine 204. This staged approach increases efficiency. In other examples, further combustors and turbines in series may be added for even greater efficiency.

Stream 211 passes through condenser 218 and stream 213 is compressed to stream 215. A portion of stream 215 is passed as stream 231 to further split into streams 237 and 235. The balance of stream 215 is cooled in second condenser 222 to form stream 217, which is compressed in second compressor 224 to form streams 219, 221, and 223.

Condensers 218 and 222 each produce water streams 245 and 243, respectively.

Stream 237 combines with oxygen stream 229 to form second oxidant stream 239. Streams 235 and 239 are optionally heated across recuperative heat exchange system 210 or may skip the exchanger 210 without heating.

Stream 221 combines with oxygen stream 227 to form first oxidant stream 241. Streams 241 and 219 are optionally heated across recuperative heat exchange system 210 or may skip the exchanger 210 without heating.

Stream 223 is passed to carbon dioxide purification unit 226 where it is compressed, dehydrated, and has NOx, SOx, and CO contaminants removed, generating an export CO₂ stream 225 at pipeline pressure.

Combustion turbines 204 and 208 may be on the same shaft, driving a single generator, or may be on separate shafts driving separate generators, such as generators 228 and 232. Either way, they drive one or more generators to produce power.

A cold secondary working fluid stream 251 is heated across the recuperative heat exchange system 210 to form secondary working fluid stream 247. Stream 247 drives cycle turbine 212, driving a shaft that drives cycle generator 232 to produce second power. Stream 249 leaves the cycle turbine 212 and is compressed in compressor 214 to produce the cold secondary working fluid stream 251.

In some examples, a portion of the secondary working fluid stream 247 is redirected as streams 253 and 255. Stream 253 is used to regenerate the dehydration unit of the air-separation unit 216. Stream 255 is used to regenerate the dehydration unit of the carbon dioxide purification unit 226.

In some examples, the carbonaceous fuel stream is natural gas or other liquid or gaseous fuels. In other examples, the carbonaceous fuel stream is a solid, such as coal.

In some examples, the secondary working fluid stream includes, or consists essentially of, steam. In other examples, the secondary working fluid stream includes, or consists essentially of, carbon dioxide. In other examples, the secondary working fluid stream includes, or consists essentially of, nitrogen.

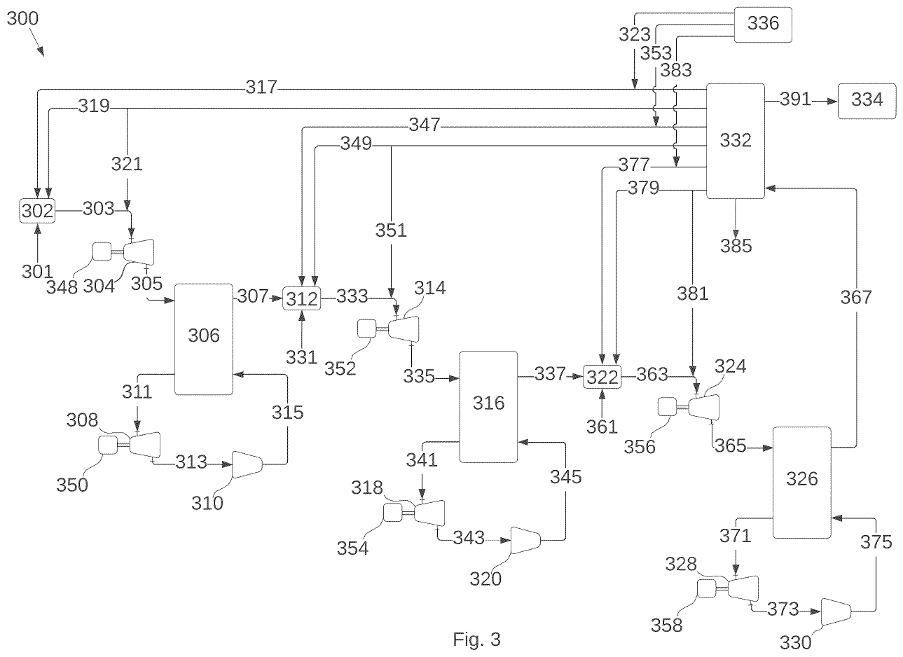

FIG. 3 is a process diagram showing an example system 300 for generating power. This example is purely illustrative, and multiple other examples are envisioned or may be readily envisioned without undue experimentation.

In some examples, system 300 is a combined cycle for generating power from two generators. In the nonlimiting configuration illustrated in FIG. 3, system 300 includes a first combustor 302, a first combustion turbine 304, a first combustion generator 348, a first recuperative heat exchange system 306, a first cycle turbine 308, a first cycle generator 350, a first cycle compressor 310, a second combustor 312, a second combustion turbine 314, a second combustion generator 352, a second recuperative heat exchange system 316, a second cycle turbine 318, a second cycle generator 354, a second cycle compressor 320, a third combustor 322, a third combustion turbine 324, a third combustion generator 356, a third recuperative heat exchange system 326, a third cycle turbine 328, a third cycle generator 358, a third cycle compressor 330, a multi-stage compressor 332, a carbon dioxide purification unit (CPU) 334, and an air-separation unit (ASU) 336.

In this example, a first fuel stream 301 is combusted with a first oxidant stream 317 in the presence of a first recycle CO₂ stream 319 in first combustor 302, producing a first combustion working fluid stream 303. A coolant stream 321, consisting primarily of CO₂, moderates the temperature of stream 303. Stream 303 is subcritical and drives first combustion turbine 304, driving generator 348, producing power, and discharging stream 305. Stream 305 is cooled across first recuperative heat exchange system 306, producing first stage discharge stream 307.

Cold first cycle working fluid stream 315 is heated across the first recuperative heat exchange system 306, producing first cycle working fluid stream 311 that drives first cycle turbine 308, driving generator 350, producing power, and discharging stream 313. Stream 313 is compressed by compressor 310 to regenerate stream 315.

A second fuel stream 331 is combusted with a second oxidant stream 347 in the presence of a second recycle CO₂ stream 349 and the first stage discharge stream 307 in second combustor 312, producing a second combustion working fluid stream 333. A coolant stream 351, consisting primarily of CO₂, moderates the temperature of stream 333. Stream 333 is subcritical and drives second combustion turbine 314, driving generator 352, producing power, and discharging stream 335. Stream 335 is cooled across second recuperative heat exchange system 316, producing second stage discharge stream 337. Cold second cycle working fluid stream 345 is heated across the second recuperative heat exchange system 316, producing second cycle working fluid stream 341 that drives second cycle turbine 318, driving generator 354, producing power, and discharging stream 343. Stream 343 is compressed by compressor 320 to regenerate stream 345.

A third fuel stream 361 is combusted with a third oxidant stream 377 in the presence of a third recycle CO₂ stream 379 and the first stage discharge stream 337 in third combustor 322, producing a third combustion working fluid stream 363. A coolant stream 381, consisting primarily of CO₂, moderates the temperature of stream 363. Stream 363 is subcritical and drives third combustion turbine 324, driving generator 356, producing power, and discharging stream 365. Stream 365 is cooled across third recuperative heat exchange system 326, producing third stage discharge stream 367. Cold third cycle working fluid stream 375 is heated across the third recuperative heat exchange system 326, producing third cycle working fluid stream 371 that drives third cycle turbine 328, driving generator 358, producing power, and discharging stream 373. Stream 373 is compressed by compressor 330 to regenerate stream 375.

In some embodiments, streams 315, 345, and 375 are water and compressors 310, 320, and 330 are the appropriate combination of heat exchangers and pumps for steam cycles.

The multi-stage compressor 332 receives the final stage stream 367, compresses and dehydrates the stream, generating water stream 385, as well as CO₂ streams for use in the multi-stage processes already described.

CPU 334 receives dry CO₂ fluid stream 391 from the multi-stage compressors and purifies the CO₂ fluid stream into an export gas.

ASU 336 generates oxygen streams 323, 353, and 383, which combine with CO₂ streams to produce streams 317, 347, and 377, respectively.

Optionally, in the example where the secondary cycles are steam (streams 311, 341, and 371), a portion of one or more of those streams can be used to regenerate the dehydration systems of CPU 334 and ASU 336.

In some examples, the ASU and CPU dehydration units include mole sieves.

FIG. 5 is a process diagram showing an example system 500 for generating power. This example is purely illustrative, and multiple other examples are envisioned or may be readily envisioned without undue experimentation.

In some examples, system 500 is a combined cycle for generating power from two generators. In the nonlimiting configuration illustrated in FIG. 5, system 500 includes a combustor 502, a combustion turbine 504, a combustion generator 520, a recuperative heat exchanger 506, an air-separation unit 508, a compression system 516, a carbon dioxide purification unit 518, a cycle turbine 510, a cycle generator 522, a condenser 512, and a pump 514.

In this example, the primary compression system 516, which includes one or more compressors, is not cooled with interstage cooling in the present example. The resultant CO₂ streams are at elevated temperatures and can be used to heat other unit operations or to be used in other unit operations directly, without cooling. The primary compression system 516 receives a first working fluid stream 505 and compresses it to produce a discharge CO₂ stream 513. The primary compression system also produces a first recycle CO₂ stream 507, or a second recycle CO₂ stream 535, or a third recycle CO₂ stream 511, or a combination thereof.

In this example, a carbonaceous fuel stream 501 is heated across recuperative heat exchange system 506 then combusted with oxidant stream 515 in the presence of the first recycle CO₂ stream 507, the second CO₂ recycle stream 535, or both, in combustor 502, producing a first working fluid stream 503. Stream 503 combines optionally with third recycle CO₂ stream 511 to drive combustion turbine 504, driving generator 520, generating first power. The discharge 505 of the turbine 504 is cooled through recuperative heat exchanger 506 and compressed in compression system 516, as described above. First recycle CO₂ stream 507 is cooled across recuperative heat exchange system 506 before being delivered to the combustor 502.

In this example, oxidant CO₂ stream 515 is either a combination of oxygen stream 539 and an oxidant CO₂ stream 509, or only oxygen stream 537. When the combination, the oxidant stream 515 is heated through recuperative heat exchange system 506. When only oxygen, oxygen stream 537 directly enters the combustor 502 without heating. The oxygen stream 539 or 537 are from air-separation unit 508.

In this example, discharge CO₂ stream 513 is processed in carbon dioxide purification unit 518, which includes cooling in condenser 520, removing contaminants such as CO, NOx, SOx, and H2O from the stream, generating export stream 517 water stream 519, and water stream 533, which act as makeup water to the bottoming cycle.

In this example, boiler feed water 527 is pumped by pump 514 through recuperative heat exchange system 506 to produce steam 521. A first portion of the steam 529 is sent to regenerate the dehydrator of the carbon dioxide purification unit 518. A second of the steam 531 is sent to regenerate the dehydrator of the air separation unit 508. The balance of the steam 521 is sent through cycle turbine 510 to drive generator 522. The cycle turbine 510 discharge 523 is passed through condenser 512 and stream 525 is combined with makeup water stream 519 to reconstitute boiler feed water 527.

In this example, heat 539 is recovered from CPU 518 and sent to recuperative heat exchange system 506 to further heat the process streams.

In some examples, the dehydrators include mole sieves.

In some examples, a method for generating power is disclosed that may be used in some examples provided herein. The method makes reference to FIG. 1 and demonstrates the method for generating power of system 100. While method optionally may be implemented using system 100, 200, 300, or 400, it will be appreciated that any other suitable combination of components may be used to implement method.

Method may include combusting a carbonaceous fuel stream and an oxidant stream in the presence of a recycle CO₂ fluid stream in a combustor, generating a working fluid stream, wherein the working fluid stream primarily consists of subcritical CO₂. For example, in a manner such as described above with reference to FIG. 1, carbonaceous fuel stream 101 and oxidant stream 115 combust in the presence of recycle CO₂ fluid stream 141 in combustor 102, generating working fluid stream 103.

Method may include passing the working fluid stream through a combustion turbine, driving a first generator, generating first power. For example, in a manner such as described above with reference to FIG. 1, working fluid stream 103 passes through combustion turbine 104 and drives generator 136 to generate first power.

Method may include cooling the working fluid stream by indirect-contact heat exchange through a recuperative heat exchange system. For example, in a manner such as described above with reference to FIG. 1, working fluid stream 105 is cooled by indirect-contact heat exchange through recuperative heat exchange system 106.

Method may include dehydrating and compressing the working fluid stream to produce a dry CO₂ fluid stream. For example, in a manner such as described above with reference to FIG. 1, working fluid stream 105 is dehydrated and compressed through condensers and compressors 118, 120, 122, 124, 126, 128, and 130 to produce the dry CO₂ fluid streams 107 and 113.

Method may include heating a first portion of the dry CO₂ fluid stream by indirect-contact heat exchange through the recuperative heat exchange system to produce the recycle CO₂ fluid stream. For example, in a manner such as described above with reference to FIG. 1, a first portion of the dry CO₂ fluid stream 107 is the recycle fluid stream 141 and passes through the exchange system 106.

Method may include producing an oxygen stream in an air-separation unit (ASU). For example, in a manner such as described above with reference to FIG. 1, the air-separation unit 108 produces an oxygen stream that combines with dry CO₂ stream 109 to produce the oxidant stream.

Method may include dehydrating the oxygen stream in an ASU dehydration unit. For example, in a manner such as described above with reference to FIG. 1, the air-separation unit 108 includes the dehydration unit.

Method may include combining the oxygen stream with a second portion of the dry CO₂ fluid stream to produce the oxidant stream. For example, in a manner such as described above with reference to FIG. 1, the oxygen stream combines with dry CO₂ fluid stream 109 to produce the oxidant stream.

Method may include heating the oxidant stream by indirect-contact heat exchange through the recuperative heat exchange system. For example, in a manner such as described above with reference to FIG. 1, the oxidant stream 115 is heated by indirect-contact heat exchange through the recuperative heat exchange system 106.

Method may include heating the carbonaceous fuel stream by indirect-contact heat exchange through the recuperative heat exchange system. For example, in a manner such as described above with reference to FIG. 2, carbonaceous fuel streams 201 and 203 are heated by indirect-contact heat exchange through recuperative heat exchange system 210.

Method may include processing a third portion of the dry CO₂ fluid stream through a carbon dioxide purification unit to produce an export CO₂ stream. For example, in a manner such as described above with reference to FIG. 1, CPU 134 receives a portion of the dry CO₂ fluid stream 115 and dehydrates it and purifies it to produce an export gas 117.

Method may include dehydrating the export CO₂ stream in a CPU dehydration unit. For example, in a manner such as described above with reference to FIG. 1, stream 117 is dehydrated by CPU dehydration unit in CPU 134, generating a water stream 119.

Method may include heating a second cold working fluid stream by indirect-contact heat exchange through the recuperative heat exchange system to produce a second working fluid stream. For example, in a manner such as described above with reference to FIG. 1, water stream 127 is heated by indirect-contact heat exchange through the recuperative heat exchange system 106 to produce steam 121.

Method may include passing a first portion of the second working fluid stream through the ASU dehydration unit to regenerate the ASU dehydration unit. For example, in a manner such as described above with reference to FIG. 1, steam stream 135 may be passed through the ASU dehydration unit in ASU 108 to regenerate the ASU dehydration unit.

Method may include passing a second portion of the second working fluid stream through the CPU dehydration unit to regenerate the CPU dehydration unit. For example, in a manner such as described above with reference to FIG. 1, steam stream 133 may be passed through the CPU dehydration unit in CPU 134 to regenerate the CPU dehydration unit.

Method may include passing a third portion of the second working fluid stream through a cycle turbine, driving a second generator, generating second power. For example, in a manner such as described above with reference to FIG. 1, steam stream 121 passes through cycle turbine 110, driving cycle generator 138, generating second power.

Method may include compressing, condensing, or compressing and condensing the third portion of the second working fluid stream to produce a portion of the cold second working fluid stream. For example, in a manner such as described above with reference to FIG. 1, stream 123 is cooled and pumped (compressed) by condenser 112 and pump 114 to produce the water stream 127. Alternatively, as in cases of non-condensable gases as working fluids, shown in FIG. 2, only compression of stream 249 by compressor 214 occurs.

In some examples, the carbonaceous fuel stream includes, or consists essentially of, natural gas.

In some examples, the carbonaceous fuel stream includes, or consists essentially of, a solid fuel.

In some examples, the processing step includes compressing a third portion of the dry CO₂ fluid stream to pipeline pressure.

In some examples, the processing step further includes removing contaminants from the third portion of the dry CO₂ fluid stream, the contaminants selected from the group consisting of NOx, SOx, CO, and water.

In some examples, the method includes transferring heat from the CPU to the recuperative heat exchange system.

In some examples, the second working fluid stream includes, or consists essentially of, steam and the method further includes passing water from the CPU to act as makeup water for the cold second working fluid stream.

In some examples, the method includes bleeding the second working fluid stream to atmosphere during an upset condition.

In some examples, the second working fluid stream includes, or consists essentially of, steam.

In some examples, the method includes using water from the dehydrating and compressing step as makeup water for the cold second working fluid stream.

In some examples, the second working fluid stream includes carbon dioxide.

In some examples, the second working fluid stream includes nitrogen.

In some examples, the method includes producing heat in an external process and passing the heat through the recuperative heat exchange system, providing heat to any process streams passing through the recuperative heat exchange system.

In some examples, the external process includes, or consists essentially of, a gas turbine.

In some examples, the method includes one or more additional combustors and one or more additional combustion turbines in series with the combustor and the combustion turbine.

The method includes combusting additional carbonaceous fuel streams with additional oxidant streams in the presence of additional recycle CO₂ streams in the one or more additional combustors. The method includes receiving the first working fluid stream and additional first working fluid streams from the combustor and the one or more additional combustors in the combustion turbine and the one or more additional combustion turbines, respectively. The method includes passing the first working fluid stream and the additional first working fluid streams from the combustion turbine and the one or more additional combustion turbines to a next of the one or more additional combustors. The method includes passing a last of the additional first working fluid streams from the last of the one or more additional combustors to the recuperative heat exchange system.

In some examples, each of the one or more additional combustors have a pressure of a previous combustion turbine discharge or a previous of the one or more additional combustion turbines discharge.

In some examples, the method includes driving the first shaft by the one or more additional combustion turbines.

In some examples, the method includes driving one or more additional shafts and one or more additional generators by the one or more additional combustion turbines.

In some examples, the recuperative heat exchange system includes, or consists essentially of, a plurality of recuperative heat exchangers in series, parallel, or series and parallel.

In some examples, the cycle turbine includes a plurality of sub-turbines on the second shaft. The method further may include passing the second working fluid stream from the plurality of sub-turbines through the recuperative heat exchange system before a next of the plurality of cycle turbines, reheating the second working fluid stream.

In some examples, the first working fluid stream enters the combustion turbine at a pressure ranging from 20 bar to 120 bar and a temperature ranging from 800 °C to 2000 °C. In other examples, the first working fluid stream enters the combustion turbine at a pressure ranging from 25 bar to 65 bar and a temperature ranging from 1100 °C to 1700 °C

In some examples, the first working fluid stream exits the combustion turbine at a pressure ranging from atmospheric pressure to below the pressure of an inlet of the combustion turbine and a temperature ranging from 600 °C to 900 °C. In other examples, the first working fluid stream exits the combustion turbine at a pressure below 5 bar and a temperature ranging from 700 °C to 800 °C.

In some examples, a method for generating power is disclosed that may be used in some examples provided herein. The method makes reference to FIG. 3 and demonstrates the method for generating power of system 300. While method optionally may be implemented using system 300, it will be appreciated that any other suitable combination of components may be used to implement method.

Method may include generating power in a plurality of staged processes.

Method may include combusting a carbonaceous fuel stream and an oxidant stream in the presence of a recycle CO₂ fluid stream in a combustor, generating a working fluid stream, wherein the working fluid stream primarily consists of subcritical CO₂. For example, in a manner such as described above with reference to FIG. 3, carbonaceous fuel streams 301, 331, and 361 are combusted with oxidant streams 317, 347, and 377, in the presence of recycle CO₂ streams 319, 349, and 379, in combustors 302, 312, and 322, respectively. This generates working fluid streams 303, 333, and 363, respectively.

Method may include passing the working fluid stream through a combustion turbine, driving a first generator, generating first power. For example, in a manner such as described above with reference to FIG. 3, the working fluids 303, 333, and 363 pass through combustion turbines 304, 314, and 324 and drive generators 348, 352, and 356, respectively, generating first power.

Method may include cooling the working fluid stream by indirect-contact heat exchange through a recuperative heat exchange system. For example, in a manner such as described above with reference to FIG. 3, working fluid streams 305, 335, and 365 are cooled in recuperative heat exchange systems 306, 316, and 326, respectively.

Method may include heating a second cold working fluid stream by indirect-contact heat exchange through the recuperative heat exchange system to produce a second working fluid stream. For example, in a manner such as described above with reference to FIG. 3, second cold working fluid streams 315, 345, and 375 are heated in the recuperative heat exchange systems 306, 316, and 326, producing second working fluid streams 311, 341, and 371, respectively.

Method may include passing the second working fluid stream through a cycle turbine, driving a second generator, generating second power. For example, in a manner such as described above with reference to FIG. 3, the second working fluid streams 311, 341, and 371 pass through cycle turbines 308, 318, and 328 and drive generators 350, 354, and 358, respectively, generating second power.

Method may include compressing, condensing, or compressing and condensing the second working fluid stream to produce the cold second working fluid stream. For example, in a manner such as described above with reference to FIG. 3, compressors 310, 320, and 330 compress streams 313, 343, and 373, producing the cold second working fluid streams 315, 345, and 375, respectively.

Method may include a previous of the plurality of staged processes passing a previous of the first working fluid streams to the combustor of a next of the plurality of staged processes. For example, in a manner such as described above with reference to FIG. 3, stream 307 passes to combustor 312 and stream 337 passes to combustor 322.

Method may include a last of the plurality of staged processes dehydrating and compressing a last of the first working fluid streams to produce a dry CO₂ fluid stream, wherein a first portion of the dry CO₂ fluid stream comprises the recycle CO₂ fluid stream. For example, in a manner such as described above with reference to FIG. 3, stream 367 passes to dehydration and compression system 332.

In some examples, the method includes producing an oxygen stream in an air-separation unit (ASU) and dehydrating the oxygen stream in an ASU dehydration unit, wherein the oxidant stream comprises a second portion of the dry CO₂ fluid stream and the oxygen stream.

In some examples, the method includes passing a second portion of the second working fluid stream through the ASU dehydration unit to regenerate the ASU dehydration unit.

In some examples, the method includes processing a third portion of the dry CO₂ fluid stream through a carbon dioxide purification unit to produce an export CO₂ stream and dehydrating the export CO₂ stream in a CPU dehydration unit.

In some examples, the method includes heating the recycle CO₂ stream through the recuperative heat exchange system.

In some examples, the method includes heating the oxidant stream through the recuperative heat exchange system.

In some examples, a method for generating power is disclosed that may be used in some examples provided herein. The method makes reference to FIG. 5 and demonstrates the method for generating power of system 500. While method optionally may be implemented using system 500, it will be appreciated that any other suitable combination of components may be used to implement method.

Method may include compressing the first working fluid stream and producing a discharge CO₂ stream and passing the discharge CO₂ stream to a carbon dioxide purification unit (CPU). This compression step may further include producing a first recycle CO₂ stream and passing the first recycle CO₂ stream to a recuperative heat exchange system and passing the first recycle CO₂ stream to a combustor, or producing a second recycle CO₂ stream and passing the second recycle CO₂ stream to the combustor, or producing a third recycle CO₂ stream and passing the third to a combustion turbine, or a combination thereof. For example, in a manner such as described above with reference to FIG. 5, the working fluid stream 505 is compressed in compression system 516 to produce the first recycle CO₂ stream 507, the second recycle CO₂ stream 535, the third recycle CO₂ stream 511, the discharge CO₂ stream 513.

Method may include combusting a carbonaceous fuel stream and an oxidant stream in the combustor in the presence of a first recycle CO₂ fluid stream, or the second recycle CO₂ stream, or both, generating the first working fluid stream. For example, in a manner such as described above with reference to FIG. 5, carbonaceous fuel stream 501 and oxidant stream 515 are combusted in the presence of first recycle CO₂ fluid stream 507 and second recycle CO₂ stream 537 in combustor 502, generating working fluid stream 503.

Method may include passing the working fluid stream and optionally the third recycle CO₂ fluid stream through the combustion turbine, driving a first generator, generating first power. For example, in a manner such as described above with reference to FIG. 5, working fluid stream 503 and third recycle CO₂ stream 511 pass through the combustion turbine 504, driving the first generator 520, generating first power.

Method may include cooling the working fluid stream and optionally the first recycle CO₂ stream by indirect-contact heat exchange through a recuperative heat exchange system. For example, in a manner such as described above with reference to FIG. 5, the working fluid stream 505 and the first recycle CO₂ stream 507 are both cooled through the recuperative heat exchange system 506.

Method may include producing an oxygen stream in an air-separation unit (ASU). For example, in a manner such as described above with reference to FIG. 5, air separation unit 508 produces the oxygen stream.

Method may include dehydrating the oxygen stream in an ASU dehydration unit. For example, in a manner such as described above with reference to FIG. 5, the oxygen stream is dehydrated in the dehydration unit of ASU 508.

Method may include processing the discharge CO₂ stream through a carbon dioxide purification unit (CPU) to produce an export CO₂ stream and optionally an oxidant CO₂ stream. For example, in a manner such as described above with reference to FIG. 5, product CO₂ stream 513 is purified through CPU 518 to produce an export stream 517 and the oxidant CO₂ stream 509.

Method may include either combining the oxygen stream with the oxidant CO₂ stream to produce the oxidant stream or passing the oxygen stream directly to the combustor as the oxidant stream. For example, in a manner such as described above with reference to FIG. 5, the oxygen stream and the oxidant CO₂ stream 509 combine to produce the oxidant stream 515.

Method may include heating the oxidant stream (only the combined oxygen stream and oxidant CO₂ stream) by indirect-contact heat exchange through the recuperative heat exchange system. For example, in a manner such as described above with reference to FIG. 5, the oxidant stream 515 is heated through recuperative heat exchange system 506, or the oxygen stream 537 is directly injected into combustor 502, or both.

Method may include dehydrating the export CO₂ stream in a CPU dehydration unit). For example, in a manner such as described above with reference to FIG. 5, the export CO₂ stream 517 is dehydrated to form water stream 519 via the dehydration unit of CPU 518.

Method may include heating a second cold working fluid stream by indirect-contact heat exchange through the recuperative heat exchange system to produce a second working fluid stream. For example, in a manner such as described above with reference to FIG. 5, the second cold working fluid stream, boiler feed water 527 is heated through recuperative heat exchange system 506 to produce the second working fluid stream, steam stream 521.

Method may include passing a first portion of the second working fluid stream through the ASU dehydration unit to regenerate the ASU dehydration unit. For example, in a manner such as described above with reference to FIG. 5, steam stream 531 is used to regenerate the ASU dehydration unit in ASU 508.

Method may include passing a second portion of the second working fluid stream through the CPU dehydration unit to regenerate the CPU dehydration unit. For example, in a manner such as described above with reference to FIG. 5, steam stream 529 is used to regenerate the CPU dehydration unit in CPU 518.

Method may include passing a third portion of the second working fluid stream through a cycle turbine, driving a second generator, generating second power. For example, in a manner such as described above with reference to FIG. 5, the third portion of the second working fluid, steam stream 521, passes through cycle turbine 510, driving the second generator 522, generating second power.

Method may include compressing, condensing, or compressing and condensing the third portion of the second working fluid stream to produce a portion of the cold second working fluid stream. For example, in a manner such as described above with reference to FIG. 5, the condenser 512 and the pump 514 condense and compress (pump) stream 525, and combined with makeup stream 519, produce boiler feed water 527.

Method may include heating the carbonaceous fuel stream by indirect-contact heat exchange through the recuperative heat exchange system before the combustor. For example, in a manner such as described above with reference to FIG. 2, where fuel streams 201 and 203 are heated through recuperative heat exchanger 210.

All patents and published patent applications referred to herein are incorporated herein by reference. The invention has been described with reference to various specific and preferred embodiments and techniques. Nevertheless, it is understood that many variations and modifications may be made while remaining within the spirit and scope of the invention.

1. A system for generating power, the system comprising:
a combustor to combust a carbonaceous fuel stream with an oxidant stream in the presence of a recycle CO₂ stream, and to produce a first working fluid stream;
a combustion turbine to receive the first working fluid stream to drive a first generator to generate first power;
a recuperative heat exchange system to cool the first working fluid stream;
a primary multistage compression system comprising one or more compressors and interstage coolers to compress and dry the first working fluid stream to produce a dry CO₂ fluid stream;
the recuperative heat exchange system to:
heat a first portion of the dry CO₂ fluid stream to produce the recycle CO₂ stream;
heat a mix of an oxygen stream and a second portion of the dry CO₂ fluid stream to produce the oxidant stream;
heat the carbonaceous fuel stream before the combustor; and
heat a cold second working fluid stream to produce a second working fluid stream;
an air-separation unit (ASU) to produce the oxygen stream, the ASU comprising an ASU dehydration unit to dehydrate the oxygen stream;
a carbon dioxide-purification unit (CPU) to process a third portion of the dry CO₂ fluid stream to produce an export CO₂ stream, the CPU comprising a CPU dehydration unit to dehydrate the export CO₂ stream;
the ASU dehydration unit to receive a first portion of the second working fluid stream to regenerate the ASU dehydration unit;
the CPU dehydration unit to receive a second portion of the second working fluid stream to regenerate the CPU dehydration unit;
a cycle turbine to receive a third portion of the second working fluid stream to drive a second generator to generate second power; and
a compression system, a condensing system, or both a compression system and a condensing system, to compress, condense, or compress and condense the third portion of the second working fluid stream to produce a portion of the cold second working fluid stream.

2. The system of claim 1, wherein the carbonaceous fuel stream comprises natural gas.

3. The system of claim 1, wherein the carbonaceous fuel stream comprises a solid fuel.

4. The system of claim 1, wherein the CPU comprises an export compressor to compress the third portion of the dry CO₂ fluid stream to pipeline pressure.

5. The system of claim 4, wherein the CPU is configured to remove contaminants from the third portion of the dry CO₂ fluid stream, the contaminants selected from the group consisting of NOx, SOx, CO, and water.

6. The system of claim 5, wherein the second working fluid stream comprises steam and wherein the water from a purification system is used as makeup water for the cold second working fluid stream.

7. The system of claim 1, further comprising a bleed valve to bleed the second working fluid stream to atmosphere during an upset condition.

8. The system of claim 1, wherein the second working fluid stream comprises steam.

9. The system of claim 8, wherein water from the primary multistage compression system is used as makeup water for the cold second working fluid stream.

10. The system of claim 1, wherein the second working fluid stream comprises carbon dioxide.

11. The system of claim 1, wherein the second working fluid stream comprises nitrogen.

12. The system of claim 1, further comprising an external process producing heat, the external process to pass the heat through the recuperative heat exchange system to provide heat to any process streams passing through the recuperative heat exchange system.

13. The system of claim 12, wherein the external process comprises a gas turbine.

14. The system of claim 1, further comprising:
one or more additional combustors and one or more additional combustion turbines in series with the combustor and the combustion turbine,
the one or more additional combustors to combust additional carbonaceous fuel streams with additional oxidant streams in the presence of additional recycle CO₂ streams,
the combustion turbine and the one or more additional combustion turbines to receive the first working fluid stream and additional first working fluid streams from the combustor and the one or more additional combustors, respectively,
the combustion turbine and the one or more additional combustion turbines to pass the first working fluid stream and the additional first working fluid streams to a next of the one or more additional combustors, and
the last of the one or more additional combustors to pass a last of the additional first working fluid streams to the recuperative heat exchange system.

15. The system of claim 14, wherein each of the one or more additional combustors comprise a pressure of a previous combustion turbine discharge or a previous of the one or more additional combustion turbines discharge.

16. The system of claim 14, wherein the combustion turbine and the one or more additional combustion turbines are configured to drive a first shaft.

17. The system of claim 14, wherein each of the one or more additional combustion turbines are configured to drive one or more additional shafts and one or more additional generators.

18. The system of claim 1, wherein the recuperative heat exchange system comprises a plurality of recuperative heat exchangers in series, parallel, or series and parallel.

19. The system of claim 1, wherein the cycle turbine comprises a plurality of sub-turbines on a second shaft, the plurality of sub-turbines to pass the second working fluid stream through the recuperative heat exchange system before a next of a plurality of cycle turbines to reheat the second working fluid stream.

20. The system of claim 1, wherein the first working fluid stream comprises subcritical CO₂.

21. The system of claim 1, wherein the first working fluid stream enters the combustion turbine at a pressure ranging from 10 bar to 120 bar and a temperature ranging from 800 °C to 2000 °C.

22. The system of claim 1, wherein the first working fluid stream enters the combustion turbine at a pressure ranging from 25 bar to 65 bar and a temperature ranging from 1100 °C to 1700 °C.

23. The system of claim 1, wherein the first working fluid stream exits the combustion turbine at a pressure ranging from atmospheric pressure to below the pressure of an inlet of the combustion turbine and a temperature ranging from 600 °C to 900 °C.

24. The system of claim 1, wherein the first working fluid stream exits the combustion turbine at a pressure below 5 bar and a temperature ranging from 700 °C to 800 °C.

25. The system of claim 1, wherein the first portion of the dry CO₂ fluid stream comprises the recycle CO₂ stream, and wherein the oxidant stream comprises the second portion of the dry CO₂ fluid stream and the oxygen stream.

26. A system for generating power, the system comprising:
a plurality of power generating units, each comprising:
a combustor to combust a carbonaceous fuel stream with an oxidant stream in the presence of a recycle CO₂ fluid stream, and to produce a first working fluid stream;
a combustion turbine to receive the first working fluid stream to drive a first generator to generate first power;
a recuperative heat exchange system to cool the first working fluid stream,
the recuperative heat exchange system to heat a cold second working fluid stream to produce a second working fluid stream;
a cycle turbine to receive the second working fluid stream to drive a second generator to generate second power; and
a compression system, a condensing system, or both a compression system and a condensing system to compress, condense, or compress and condense the second working
fluid stream to produce the cold second working fluid stream;
a previous of the plurality of power generating units to pass a previous of the first working fluid streams to the combustor of a next of the plurality of power generating units;
a last of the plurality of power generating units to pass a last of the first working fluid streams to a primary multistage compression system; and
the primary multistage compression system comprising one or more compressors and interstage coolers to compress and dry the last of the first working fluid streams to produce a dry CO₂ fluid stream, wherein a first portion of the dry CO₂ fluid stream comprises the recycle CO₂ fluid stream.

27. (canceled)

28. (canceled)

29. (canceled)

30. (canceled)

31. (canceled)

32. (canceled)

33. (canceled)

34. A system for generating power, the system comprising:
a primary compression system to compress a first working fluid stream to:
produce a discharge CO₂ stream and to pass the discharge CO₂ stream to a carbon dioxide purification unit (CPU), and
produce one or more recycle CO₂ streams;
a combustor to combust a carbonaceous fuel stream and an oxidant stream in the presence of one or more of the recycle CO₂ streams to produce a first working fluid stream;
a combustion turbine to use the first working fluid stream to drive a first generator to generate first power;
a recuperative heat exchange system to:
cool the first working fluid stream; and
heat a second working fluid stream;
a carbon dioxide purification unit (CPU), comprising a CPU dehydration unit, to:
cool, process, and dehydrate the discharge CO₂ stream to produce an oxidant CO₂ stream and an export CO₂ stream; and
receive a first portion of the second working fluid stream to regenerate the CPU dehydration unit;
an air-separation unit (ASU), comprising an ASU dehydration unit, to:
produce and dehydrate at least a portion of the oxidant stream; and
receive a second portion of the second working fluid stream to regenerate the ASU dehydration unit;
a cycle turbine to use a third portion of the second working fluid stream to drive a second generator to generate second power; and
a cycle compression system, a cycle condensing system, or both a cycle compression system and a cycle condensing system to compress, condense, or compress and condense the third portion of the second working fluid stream.

35. (canceled)

36. The system of claim 34, wherein the recuperative heat exchange system further is to heat one of the one or more recycle CO₂ streams passing into the combustor.

37. (canceled)

38. (canceled)

39. (canceled)

40. The system of claim 34, wherein the primary compression system further is to pass one of the one or more recycle CO₂ streams to the combustion turbine to further drive the first generator.

41. (canceled)

42. (canceled)

43. A method for generating power, the method comprising:
combusting a carbonaceous fuel stream and an oxidant stream in the presence of a recycle CO₂ fluid stream in a combustor, generating a first working fluid stream;
passing the first working fluid stream through a combustion turbine, driving a first generator, generating first power;
cooling the first working fluid stream by indirect-contact heat exchange through a recuperative heat exchange system;
dehydrating and compressing the first working fluid stream to produce a dry CO₂ fluid stream;
heating a first portion of the dry CO₂ fluid stream by indirect-contact heat exchange through the recuperative heat exchange system to produce the recycle CO₂ fluid stream;
producing an oxygen stream in an air-separation unit (ASU);
dehydrating the oxygen stream in an ASU dehydration unit;
combining the oxygen stream with a second portion of the dry CO₂ fluid stream to produce the oxidant stream;
heating the oxidant stream by indirect-contact heat exchange through the recuperative heat exchange system;
heating the carbonaceous fuel stream by indirect-contact heat exchange through the recuperative heat exchange system;
processing a third portion of the dry CO₂ fluid stream through a carbon dioxide purification unit to produce an export CO₂ stream;
dehydrating the export CO₂ stream in a CPU dehydration unit;
heating a second cold working fluid stream by indirect-contact heat exchange through the recuperative heat exchange system to produce a second working fluid stream;
passing a first portion of the second working fluid stream through the ASU dehydration unit to regenerate the ASU dehydration unit;
passing a second portion of the second working fluid stream through the CPU dehydration unit to regenerate the CPU dehydration unit;
passing a third portion of the second working fluid stream through a cycle turbine, driving a second generator, generating second power; and
compressing, condensing, or compressing and condensing the third portion of the second working fluid stream to produce a portion of the cold second working fluid stream.

44. (canceled)

45. (canceled)

46. (canceled)

47. (canceled)

48. The method of claim 43, further comprising transferring heat from the CPU to the recuperative heat exchange system.

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. The method of claim 43, wherein the first portion of the dry CO₂ fluid stream comprises the recycle CO₂ fluid stream, and wherein the oxidant stream comprises the second portion of the dry CO₂ fluid stream and the oxygen stream.

69. A method for generating power, the method comprising:
generating power in a plurality of staged processes, each of the processes comprising:
combusting a carbonaceous fuel stream and an oxidant stream in the presence of a recycle CO₂ fluid stream in a combustor, generating a first working fluid stream;
passing the first working fluid stream through a combustion turbine, driving a first generator, generating first power;
cooling the first working fluid stream by indirect-contact heat exchange through a recuperative heat exchange system;
heating a second cold working fluid stream by indirect-contact heat exchange through the recuperative heat exchange system to produce a second working fluid stream;
passing the second working fluid stream through a cycle turbine, driving a second generator, generating second power; and
compressing, condensing, or compressing and condensing the second working fluid stream to produce the cold second working fluid stream;
wherein a previous of the plurality of staged processes passes a previous of the first working fluid streams to the combustor of a next of the plurality of staged processes; and
a last of the plurality of staged processes dehydrates and compresses a last of the first working fluid streams to produce a dry CO₂ fluid stream, wherein a first portion of the dry CO₂ fluid stream comprises the recycle CO₂ fluid stream.

70. (canceled)

71. (canceled)

72. (canceled)

73. (canceled)

74. (canceled)

75. (canceled)

76. A method for generating power, the method comprising:
compressing a first working fluid stream, producing a discharge CO₂ stream and one or more recycle CO₂ streams;
passing the discharge CO₂ stream to a carbon dioxide purification unit (CPU);
combusting a carbonaceous fuel stream and an oxidant stream in a combustor in the presence of one or more of the recycle CO₂ fluid streams, generating a first working fluid stream;
passing the first working fluid stream through a combustion turbine, driving a first generator, generating first power;
cooling the working fluid stream by indirect-contact heat exchange through a recuperative heat exchange system;
producing and dehydrating at least a portion of the oxidant stream in an air-separation unit (ASU) comprising an ASU dehydration unit;
cooling, processing, and dehydrating the discharge CO₂ stream through the CPU to produce an export CO₂ stream, the CPU comprising a CPU dehydration unit;
heating a second cold working fluid stream by indirect-contact heat exchange through the recuperative heat exchange system to produce a second working fluid stream;
passing a first portion of the second working fluid stream through the ASU dehydration unit to regenerate the ASU dehydration unit;
passing a second portion of the second working fluid stream through the CPU dehydration unit to regenerate the CPU dehydration unit;
passing a third portion of the second working fluid stream through a cycle turbine, driving a second generator, generating second power; and
compressing, condensing, or compressing and condensing the third portion of the second working fluid stream to produce a portion of the cold second working fluid stream.

77. (canceled)

78. (canceled)

79. (canceled)

80. (canceled)

81. (canceled)

82. (canceled)

83. (canceled)
